(19) United States
(12) Patent Application Publication
(10) Pub. No.: US 2019/0296287 A1
(43) Pub. Date: Sep. 26, 2019

(54) BATTYERY ASSEMBLY FOR BATTERY PACK

(71) Applicant: VOLTABOX AG, Delbrueck (DE)

(72) Inventors: Jochen STICHLING, Beckum (DE); Constantin Werth, Paderborn-Wewer (DE)

(21) Appl. No.: 16/358,339

(22) Filed: Mar. 19, 2019

(30) Foreign Application Priority Data
Mar. 21, 2018 (DE) 102018002334.7

(51) Int. Cl. H01M 2/10; H01M 2/20

(52) U.S. Cl. CPC H01M 2/1077; H01M 2220/20; H01M 2/206

(57) ABSTRACT

A battery assembly has a plurality of laterally adjacent frames, respective battery cells fixed in the frames, and respective pole extenders projecting upward from the cells and each having an outer end that is horizontally bent to form a downwardly directed lower extender face. A conductive connector has for each of the cells a respective connector arm and is insertable into the frames into a position with the arms under the lower faces of the respective outer ends. A wedge bears upward on the connector arms, downward on the frame or cells, and presses the arms upward against the lower faces of the outer ends of the respective extenders. A wedge formation on the frame is underneath and bears upward on the wedge.

### FIELD OF THE INVENTION

The present invention relates to a battery pack. More particularly this invention concerns a battery assembly for holding cells in a battery pack.

### BACKGROUND OF THE INVENTION

The invention relates to a battery assembly for a battery pack and comprising a battery cell, a frame holding the battery cell, a pole extender that on one side is connected to the battery cell and that at the opposite outer side or end projects out of the battery cell, and a connector, to which the connector outer end of the pole extender is connected and that can connect the battery cell to adjacent battery cells of the battery pack.

### OBJECTS OF THE INVENTION

It is therefore an object of the present invention to provide an improved battery assembly for a battery pack.

Another object is the provision of such an improved battery assembly for a battery pack that overcomes the above-given disadvantages, in particular whose installation and removal is simplified considerably using the connector connecting it to adjacent battery assemblies and in which a reliable terminal connection between the connector and the outer ends of the pole extenders is ensured long-term.

### SUMMARY OF THE INVENTION

A battery assembly for a battery pack has according to the invention a battery cell, a frame holding the battery cell, a pole extender that has one side is connected to the battery cell and an opposite side projecting away from the battery cell and having an outer end with a lower downwardly directed face turned toward the cell. A connector is fittable with the outer end of the extender and can connect the battery cell to adjacent battery cells of the battery pack. The connector has an upper face flatly engaging the lower face of the extender when the connector is fitted to the extender. A wedge is fixed underneath the connector, bears downward on the cells or the frame, and has a pair of wedge faces forming a small acute angle with each other so that the connector is pressed upward against the outer-end lower face.

In other words, this object is achieved in that the connector outer end of the pole extender is bent into a connection plane arranged perpendicularly to the main plane of the battery cell, in that the extender outer end is, by way of the lower face thereof, connected in a planar manner to the surface of the connector facing the same, in that an oblique plane is formed below the connector, and in that a wedge sits between the oblique plane below the connector and the battery cell or the frame thereof, the inclined upper face of which is complementary to the inclined lower face of the oblique plane below the connector. During the mounting of the connector, which can take place by means of lateral insertion or pushing in, it is ensured owing to the connecting-part-side oblique plane and the battery-cell-unit-side wedge, that a height compensation takes place during the lateral insertion. During the lateral insertion of the connector, the connector is brought closer to its ultimate mounting position on a straight line using two direction vectors. Here, height compensation can take place, which is important for the materially connected connection to be produced between the connector and the pole extenders. The surface of the connector is brought parallel from below to the outer ends of the pole extender. By means of a connector having a different number of connecting arms, the combination thereof and a number of battery assemblies adapted thereto, battery packs of any desired capacity can be assembled. This is important in the design of vehicle drive batteries in particular.

According to an advantageous development of the battery assembly according to the invention, the oblique plane constructed below the connector is the lower face of a base element, on the surface of which the connector is held. As a result, it is for example possible for the battery assemblies according to the invention to use standardized connectors, wherein an adaptation of the connectors to the battery pack to actually be assembled in each case is possible by means of the base element.

For a secure connection between connector on the one hand and base element on the other hand, it is advantageous if the connector is securely locked on the surface of the base element by means of mounting formations or tabs.

The battery cell of the battery assembly according to the invention can advantageously be fixed in the frame of the battery assembly, wherein the fixing can preferably be realized in that the battery cell is adhesively bonded, clamped and/or pushed into the frame.

The wedge of the battery assembly according to the invention can expediently be mounted on the frame of the same.

Alternatively, it is possible to configure the wedge as an integral constituent of the frame.

In order to exclude or to minimize mechanical loads, e.g. owing to vibrations, etc., of the terminal connection between the outer ends of the pole extenders on one side and the connector on the other side, it is advantageous if a relief profile is constructed between a section of the pole extender parallel to the main plane of the battery cell and projecting from the same on one side and the outer end of the pole extender bent at right angles thereto on the other side.

### BRIEF DESCRIPTION OF THE DRAWING

The above and other objects, features, and advantages will become more readily apparent from the following description, reference being made to the accompanying drawing in which:

FIG. 1 is a view of three battery assemblies according to the invention, with a single one connector to be joined with these battery assemblies prior to the joining;

FIG. 2 is a view like FIG. 1 of the battery assemblies during joining the connector to the battery assemblies;

FIG. 3 is a view like FIGS. 1 and 2 after joining the battery assemblies to the connector;

FIG. 4 is a view like FIG. 1 of a plurality of battery assemblies according to the invention that are connected to one another by two connectors shown prior to their joining to the battery assemblies;

FIG. 5 is a view like FIG. 4 where one of the two connectors is shown during the joining and the other is shown prior to joining to the battery assemblies;

FIG. 6 is a view like FIGS. 4 and 5 where one connector is shown joined and the other connector prior to joining;

FIG. 7 is a view like FIGS. 4 to 6 where one connector is shown in the joined state and the other connector is shown during joining; and

FIG. 8 is a view like FIGS. 4 to 7 where both connectors are shown in the joined state.

### SPECIFIC DESCRIPTION OF THE INVENTION

As seen in FIG. 1, each battery assembly 1 according to the invention is to be joined to further identical battery assemblies 1 to form a battery pack having a plurality of such battery assemblies 1. Each assembly 1 is formed by a battery cell 2, a frame 3 and pole extenders 4.

The battery cell 2 of the battery assembly 1 is inserted into the frame 3 of the battery assembly so that the battery cell 2 is fixed therein. The fixing can be realized in that the battery cell 2 is adhesively bonded, clamped and/or press fitted into the frame 3.

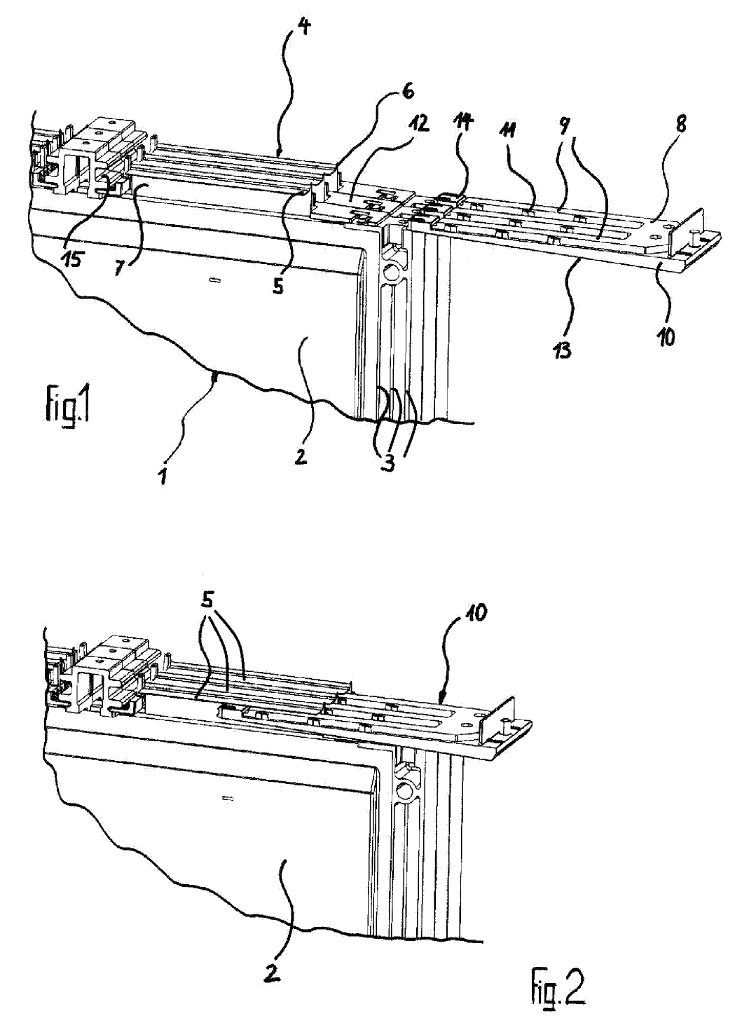

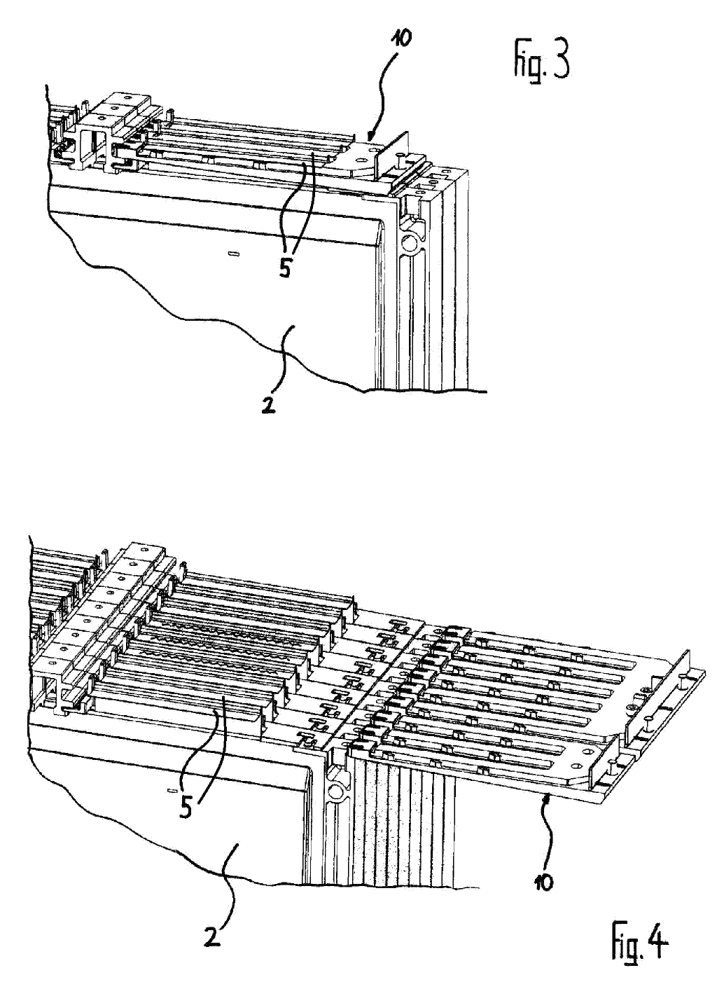

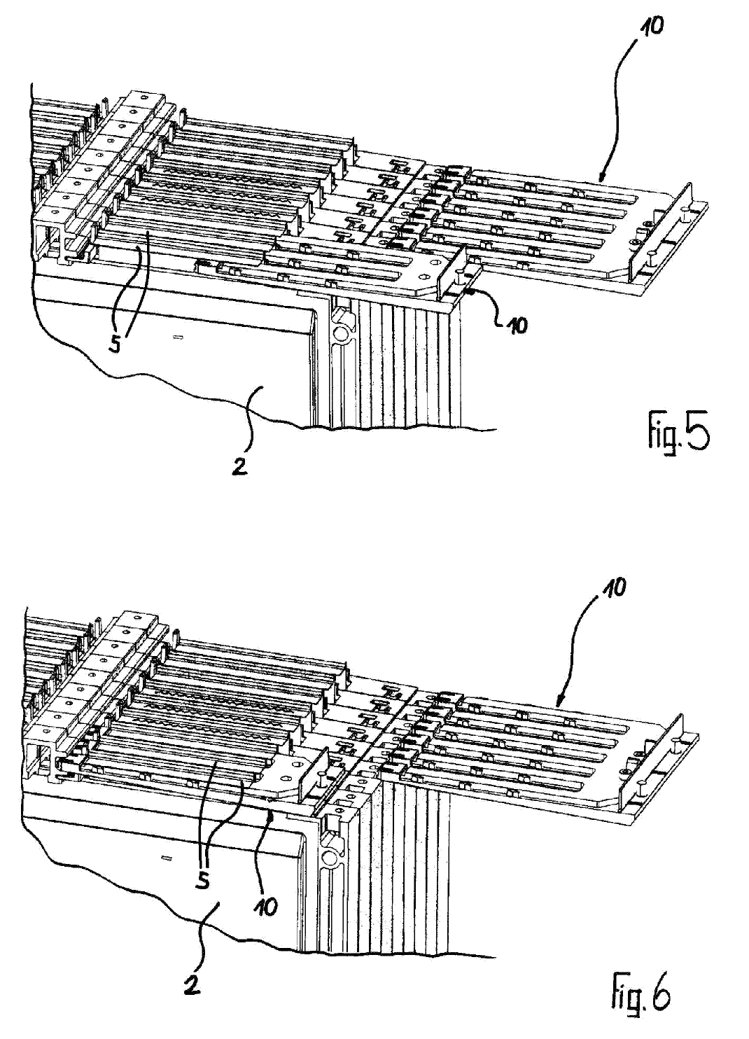

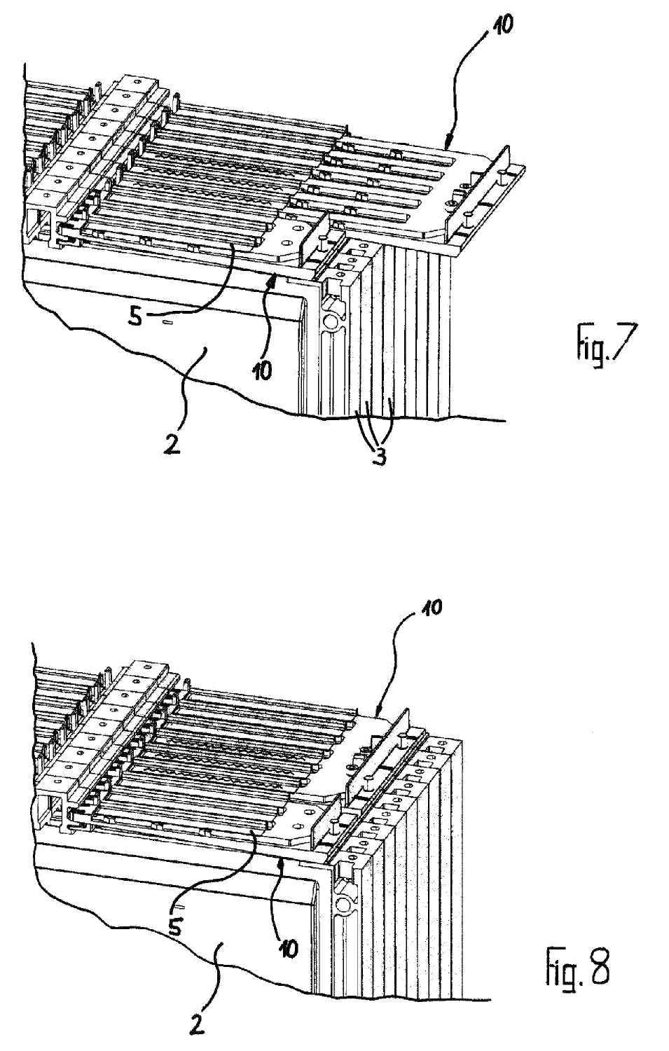

Each pole extender 4 shown in FIGS. 1 to 3 has an outer end 5 connected to the outer end 5 of the extenders 2 of the adjacent battery cell 2 of the battery assembly 1. The outer end 5 of each pole extender 4 projects out of the respective battery cell 2 of the battery assembly 1.

In the delivery state shown in the drawing, the outer end 5 of each pole extender 4 projects out of the respective battery cell 2 of the battery assembly 1. To install the battery assembly 1, the outer end 5 of the pole extender 4 extends at 90° in a here horizontal connection plane itself extending perpendicular to the here vertical main plane of the battery cell 2. In FIGS. 1 to 8, each pole extender 4 is thus bent. Furthermore, each pole extender 4 of the battery assembly shown in FIGS. 1 to 8 is configured with a relief profile 6 in each case that is constructed between a section 7 of the pole extender 4 parallel to the main plane of the battery cell 2 and projecting from the same and the extender outer end 5 bent at right angles thereto.

The relief contour 6 comprises curved and planar sections and is used, in the joined state of the battery assembly, to prevent vibrations etc. from being transmitted to a materially connected connection between the pole extenders 4 on one side and a connector 8 that connects adjacent battery assemblies 1 to one another on the other side.

The connector 8 shown in FIGS. 1 to 3 is suitable for connecting three adjacent battery assemblies 1 to one another. To this end, the connector 8 can be brought at connecting arms 9 thereof into flat contact with the lower faces of the bent outer ends 5 of the pole extenders 4.

For uniform contact between the connecting arms 9 of the connector 8 on the other side and the outer ends 5 of the pole extenders 4, in the case of the battery assembly 1 according to the invention, the connector 8 is pushed from the side, as can be seen from FIGS. 1 to 3, between the battery cells 2 of the battery assembly 1 and the extender outer end 5 of the pole extender 4 of the battery assembly 1 in such a manner that flat surface contact between the connecting arm 9 of the connector 8 and the extender outer end 5 of the pole extender 4 results.

To this end, in the embodiment of the battery assembly 1 according to the invention, the connector 8 is held on a wedge-shaped base element 10 that is provided with mounting formations or tabs 11 that securely secure the connector 8 to the upper face of the base element 10 and thus fix it there. The connector 8 is thus securely fixed to the base element 10.

In order, during the lateral pushing-in of the connector 8 locked on the base element 10 into the battery assemblies 1, that this insertion process is easy and to ensure that at the end of this insertion process, uniform surface contact is provided between the connecting arms 9 of the connector 8 on one side and the bent outer ends 5 of the pole extenders 4 on the other side, in the illustrated embodiment of the battery assembly according to the invention, a wedge formation 12 is formed on the frame 3 and has a sloped upper face complementary to a sloped lower face 13 of the base element 10 so that it is parallel to an upper face of the base element 10.

During the insertion process, the connecting arms 9 of the connector 8 can be brought successively closer to the outer ends 5 of the pole extenders 4, until they are located in the fully inserted state of the connector 8 in flat surface contact with the outer ends 5 of the pole extenders 4.

In the fully inserted state of the base element 10, locking formations 14 formed on the inserted end of the base element 10 are in engagement with locking formations 15 on the battery assembly 1. As the arms 9 of the connector 8 fixed to the base element 10 slide in underneath the outer ends 5, the complementary faces 10 and 12 engage and push the arms 9 up against the ends 5 while pressing the base element 10 down against the frames 3.

The complementary interfit between the base element 10 and extender outer ends 5 and the vertical dimensions of the unit from the base element 10 and connector 8 on the other hand, ensure that at the end of the insertion process, good surface contact is formed between the connecting arms 9 and the extender outer ends 5 with a desired contact pressure, in order to ensure an orderly connection of the battery assemblies 1 to the connector 8 long-term.

The battery-cell wedge surface 12 can be constructed integrally with the frame 3 of the battery assembly 1.

Alternatively, it is of course possible to configure the wedge 12 as a separate component that can be mounted on the frame 3.

A further embodiment, shown in FIGS. 4 to 8, of a battery pack assembled from a plurality of battery assemblies 1 has nine battery assemblies 1 that are connected to one another by two a front connector 8 with has three connecting arms 9 and a rear connector 8 with six connecting arms 9.

During removal of the battery packs, it is possible to separate the connectors 8 by lateral extraction from the battery assemblies 1, which is of course true for all embodiments, as are shown in FIGS. 1 to 8.

In the mounted state, the connector 8 is securely locked under the outer ends 5 of the pole extenders of the adjacent battery assemblies 1. A subsequent and compensating mounting or removal of the connector 8 is enabled by the angled wedge faces 13 and 11. Owing to the interaction between the oblique wedge faces 11 and 13, the connector 8 is guided parallel and from below onto the outer ends 5 of the pole extenders 4. The gradual height compensation is important for a connection to be produced between the outer ends 5 of the pole extenders 4 on one side and the connecting arms 9 of the connector 8 on the other side. Solid mountings of this type are shown by way of example in FIGS. 4 to 8. Here, this may be welding seams in particular.

We claim:

1. A battery assembly for a battery pack, the assembly comprising:
a battery cell;
a frame holding the battery cell;
a pole extender that has one side connected to the battery cell and an opposite side projecting away from the battery cell and having an outer end with a lower downwardly directed face turned toward the cell;
a connector fittable with the extender, to which the outer end of the pole extender is connected, and that can connect the battery cell to adjacent battery cells of the battery pack, the connector having an upper face underneath and flatly engaging the lower face of the extender when the connector is fitted to the extender;
a wedge fixed underneath the connector, bearing downward on the frame, and having a pair of wedge faces forming a small acute angle with each other to press the connector upward against the lower face of the outer end; and
a wedge formation on the frame underneath and bearing upward on the wedge.

2. The battery assembly defined in claim 1, wherein the one wedge face is a lower face of the wedge bearing downward on the frame or cell.

3. The battery assembly defined in claim 1, further comprising:
mounting formations fixing the connector on the base.

4. The battery assembly defined in claim 1, wherein the battery cell is fixed by adhesive bonding, clamping or press fit in the frame.

5. The battery assembly defined in claim 1, wherein the wedge is mounted on the frame.

6. The battery assembly defined in claim 5, wherein the wedge is integral with the frame.

7. The battery assembly defined in claim 1, wherein a relief profile is formed on the pole extender, extends parallel to a main plane of the battery cell, and projects from the extender on one side and the outer end of the pole extender.

8. A battery assembly comprising:
a plurality of laterally adjacent frames each formed with an upwardly directed wedge face;
respective battery cells fixed in the frames;
respective pole extenders projecting upward from the cells and each having an outer end that is horizontally bent to form a downwardly directed lower extender face extending at a small acute angle to the wedge faces;
a conductive connector having for each of the cells a respective connector arm and being insertable between the outer ends of the extenders into a position with the arms under the lower faces of the respective outer ends; and
a wedge bearing upward on the connector arms, downward via a lower wedge face on the upwardly directed wedge faces of the frame, and pressing the arms upward against the lower faces of the outer ends of the respective extenders when the connector is inserted into the frame.

9. The assembly defined in claim 8, wherein the wedge faces are parallel to each other, grip the respective arms, the arms being of uniform vertical thickness.
